(19) United States
(12) Patent Application Publication
(10) Pub. No.: US 2023/0099276 A1
(43) Pub. Date: Mar. 30, 2023

(54) OPPORTUNISTIC DEVICE RECOVERY FROM BEAM FAILURES

(71) Applicant: Apple Inc., Cupertino, CA (US)

(72) Inventors: Muhammad Saad, Sashse, TX (US); Syed A. Rahim, Allen, TX (US); Nitin A. Naik, San Jose, CA (US); Gopi Krishna Koneru, Milpitas, CA (US); Vijay Venkataraman, San Jose, CA (US); Neeraj D. Vaghela, San Jose, CA (US)

(21) Appl. No.: 17/945,524

(22) Filed: Sep. 15, 2022

Related U.S. Application Data
(60) Provisional application No. 63/248,308, filed on Sep. 24, 2021.

(51) Int. Cl. H04B 7/06; H04W 74/08; H04W 72/04; H04B 17/318

(52) U.S. Cl. CPC H04B 7/0695; H04W 74/0833; H04W 72/046; H04B 17/318

(57) ABSTRACT

Systems and processes are for measuring link metrics for a plurality of reference signals associated with a plurality of beams from a base station. The systems and methods are for determining that a link metric value is less than or equal to a predetermined threshold. The systems and process include detecting beam failure, classifying beam recovery as high priority, opportunistic beam failure recovery and performing an optimal random access channel (RACH) process through intelligent selection of beams and modules.

### CLAIM OF PRIORITY

This application claims priority under 35 U.S.C. § 119(e) to U.S. Patent Application Ser. No. 63/248,308, filed on Sep. 24, 2021, the entire contents of which are hereby incorporated by reference.

### BACKGROUND

Wireless communication networks provide integrated communication platforms and telecommunication services to wireless user devices. Example telecommunication services include telephony, data (e.g., voice, audio, and/or video data), messaging, internet-access, and/or other services. The wireless communication networks have wireless access nodes that exchange wireless signals with the wireless user devices using wireless network protocols, such as protocols described in various telecommunication standards promulgated by the Third Generation Partnership Project (3GPP). Example wireless communication networks include Long Term Evolution (LTE), and Fifth Generation New Radio (5G NR).

### SUMMARY

This specification describes systems and processes for device recovery from a beam failure, such as for 5G NR networks. The UE, when beam failure is detected, immediately begins attempting to recover the beam. The UE does not wait for a BeamFailureIndication counter to exhaust or for a BeamFailureDetection timer to expire. Typically, when beam failure is detected, the UE beings to count beam failure detections. When a threshold number of detections is reached and the beam failure timer expires, the UE beings beam recovery using random access channel (RACH) messages. A legacy UE reconnects to the NR network, when available, after waiting for the counter to exhaust or for a timer to expire. The processes described herein enable the UE to bypass the timer and counter requirements and recover the beam more quickly.

When a user equipment (UE) is operating in Evolved-Universal Terrestrial Radio Access-New Radio (EN-DC), a base station (e.g., a gNodeB (gNB)) serving the UE configures the UE to send measurement reports for channel state information reference signal (CSI-RS) resources, Synchronization Signal Block (SSB) resources (also referred to as SS/Physical Broadcast Channel (PBCH) or SS/PBCH), or both CSI-RS and SSB resources. Each SSB resource may be associated with a beam from a plurality of beams called SSB beams. The UE searches for and measures the SSB beams. The UE maintains a set of candidate beams. The candidate set of beams may contain beams from multiple cells of the network. The UE uses a Physical Cell ID (PCI) and a beam ID to identify particular beams in the set.

The UE reports the SSB ID and the corresponding reference signal receive power (RSRP) in the channel state function. The network that assigns a Transmission Configuration Indicator (TCI) state in the MAC-CE instructs the UE to move the particular TCI that corresponds to a SSB ID. Transmission Configuration Indicator (TCI) states are dynamically sent over in a downlink control information (DCI) message. The DCI message includes configurations such as quasi co-location (QCL) relationships between the downlink (DL) reference signals (RSs) in one CSI-RS set and the Physical Data Shared Channel (PDSCH) Demodulation Reference Signal (DMRS) ports. The UE can be configured with a list of up to “M” TCI-State configurations within the higher layer (RRC ReConfig) parameter PDSCH-Config to decode PDSCH according to a detected PDCCH with DCI intended for the UE and the given serving cell, where M depends on the UE capability maxNumberActiveTCI-PerBWP.

Each TCI-State contains parameters for configuring a QCL relationship between one or two downlink reference signals and the DM-RS ports of the PDSCH, the DM-RS port of PDCCH or the CSI-RS port(s) of a CSI-RS resource. The QCL relationship is configured by the higher layer (RRC Reconfig) parameter qcl-Type1 for the first DL RS, and qcl-Type2 for the second DL RS. A maximum of two qcl-types per TCI state can be configured. For the case of two DLRSs, the QCL types are different, regardless of whether the references are to the same DLRS or different DLRSs

The UE uses the SSB ID received in the MAC-CE. In some implementations, the SSB signal could be affected by the UL block error ratio (BLER). The SSB index encoded in the CSF could be wrongly interpreted by the base station due to UL BLER. The UL UCI could be lost. A result would be that the UE uses a relatively weaker beam (e.g., a wrong beam or non-best beam) and does not switch to a better beam. The use of a weaker beam by the UE can result in a relatively higher BLER than for use of a stronger beam. The beam may eventually fail such that the UE starts a beam failure recovery process followed by NR secondary cell group (SCG) connection failure. In another example, the UE selects a beam with poor energy metrics, resulting in a higher BLER. The UE eventually goes into beam failure recovery mode, followed by NR removal. A result from is that the user has a poor experience as data stalls on 5G-NR. The user may not be able to use 5G NR, and experiences a lower data throughput.

To overcome these potential issues, the UE performs an opportunistic beam failure recovery. The UE performs beam failure recovery without having to wait for a beam failure indication counter to exhaust. The UE performs beam failure recovery without waiting for a beam failure detection timer to expire.

The opportunistic beam failure recovery enables one or more of the following advantages. The operations enable faster beam recovery by a UE than if conventional beam recovery is used. The UE does not have to wait for the NR cell to be removed to recover the beam. The UE avoids data stall. Data can stall when a beam RSRP of the SSB dips just after a UE is instructed from the network to move to an incorrect SSB. The beam failure recovery enables the UE to avoid switching to an incorrect SSB, avoiding the data stall. In another example, a data payload for the UE is increased because the UE is able to stay on the NR connection more reliably. The UE avoids spending time and computing resources for needless and incorrect SSB switching, and can use these resources for maximizing a data throughput. This improves the overall data experience, and the user is less likely to experience a drop from 5G NR connections.

The details of one or more embodiments of these systems and methods are set forth in the accompanying drawings and the description below. Other features, objects, and advantages of these systems and methods will be apparent from the description and drawings, and from the claims.

### BRIEF DESCRIPTION OF THE FIGURES

FIGS. 1A-1B include a flow diagram that illustrates process for opportunistic device recovery from transmission beam failures, in accordance with some embodiments.

FIG. 2 shows a flow diagram of a state machine for use with the process of FIGS. 1A-1B.

FIG. 3 shows a flow diagram that illustrates process for opportunistic device recovery from transmission beam failures.

FIG. 4 illustrates a wireless network, in accordance with some embodiments.

FIG. 5 illustrates a user equipment (UE), in accordance with some embodiments.

FIG. 6 illustrates an access node, in accordance with some embodiments.

### DETAILED DESCRIPTION

This specification describes systems and processes for device recovery from a beam failure, such as for 5G NR networks. The UE performs beam failure recovery without having to wait for a beam failure indication counter to exhaust. When the UE detects beam failure the UE immediately (e.g., with minimal latency) beings the beam recovery process. In legacy processes, the UE sets a value for a BeamFailureIndication parameter to true and increments a counter. The UE starts running a BeamfailureDetection timer. When the BeamFailureIndication counter reaches a threshold value, and the BeamFailureDectection timer expires, the UE enters a beam failure recovery mode. The UE sends a message using the random access channel (RACH) procedure to connect to the NR network.

The processes described herein enable the UE to perform beam failure recovery without waiting for a beam failure detection timer to expire or for the counter to reach a threshold value. The processes described herein enable the UE to bypass the timer and counter requirements and recover the beam more quickly.

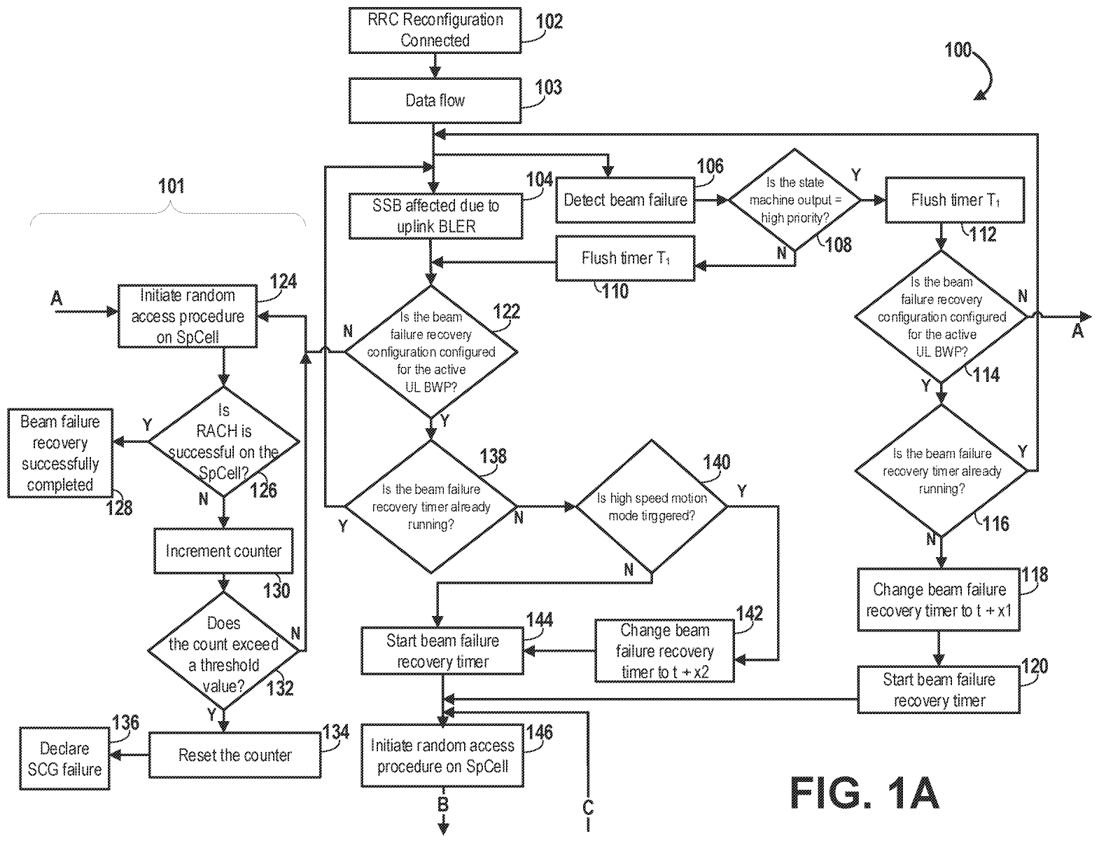

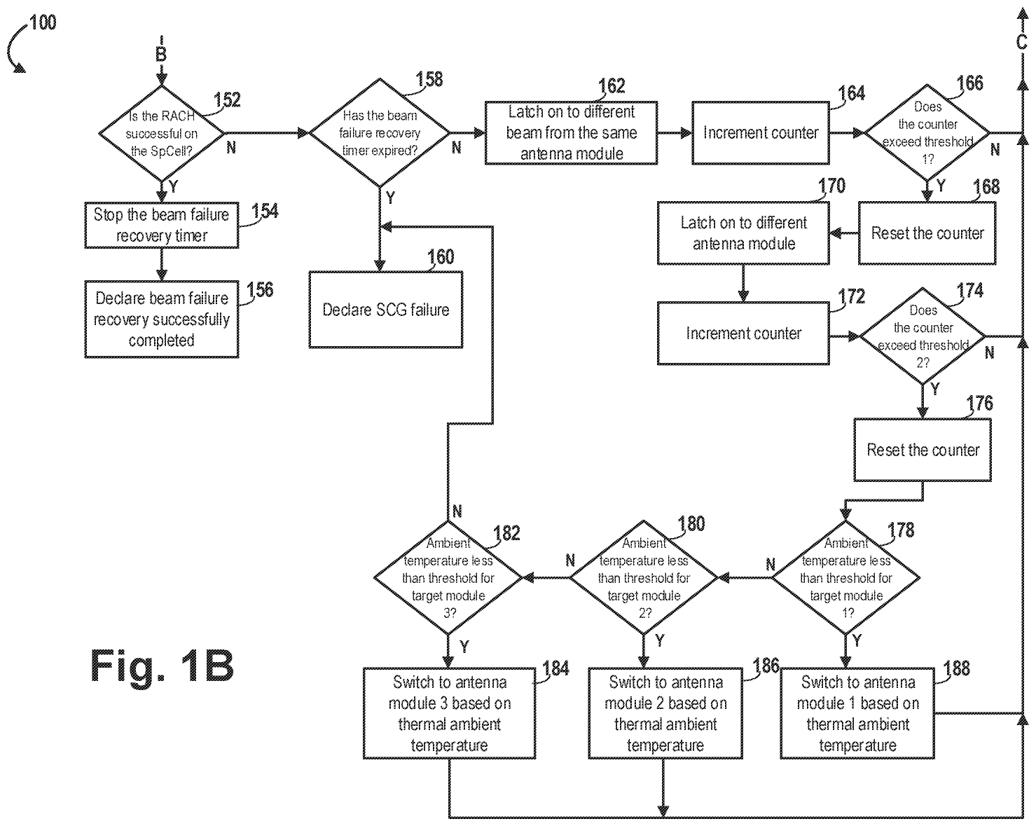

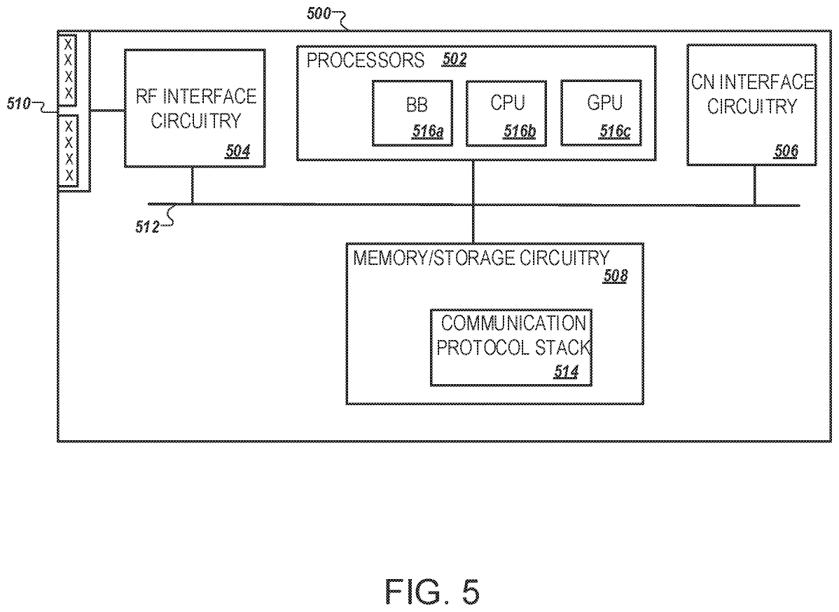

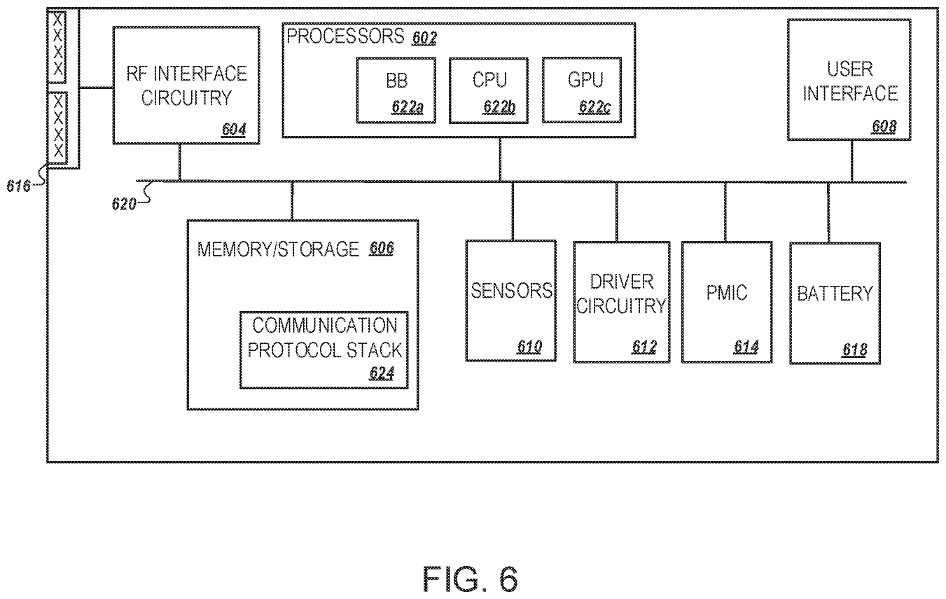

FIGS. 1A-1B show an example process 100 for beam failure recovery. The process of FIG. 1A connects to the process 100 of FIG. 1B at points B and C. The UE can include the UE 600 subsequently described in relation to FIGS. 5-6. For process 100, opportunistic beam failure recovery is performed without the UE waiting for the BeamFailureIndication counter to exhaust or the BeamFailureDetection timer to expire. The UE avoids moving from a NR beam, which is eventually be removed when the SSB is affected due to UCI corruption, UL BLER, or poor RF.

The UE connects (102) using RRC reconfiguration. The UE operates, such as using an NR beam, and the UE transmits and receives data using data flow (103). The UE can detect one of two scenarios. In some implementations, the UE detects (104) that the SSB is being affected due to uplink (UL) BLER. SSB can be affected by uplink BLER because the SSB index encoded in CSI is incorrectly decoded by the base station (e.g., an access node 500 of FIG. 5) because of the UL BLER. The base station can incorrectly decode the SSB index when the UL uplink control information (UCI) is lost, and the UE remains on a relatively weaker beam than the ideal beam or strongest beam.

In a second scenario, the UE detects (106) that beam failure has occurred. In this scenario, the UE executes (108) a state machine to determine whether to perform a high priority recovery process or a low priority recovery process. Each of these processes are subsequently described and shown as part of FIGS. 1A-1B.

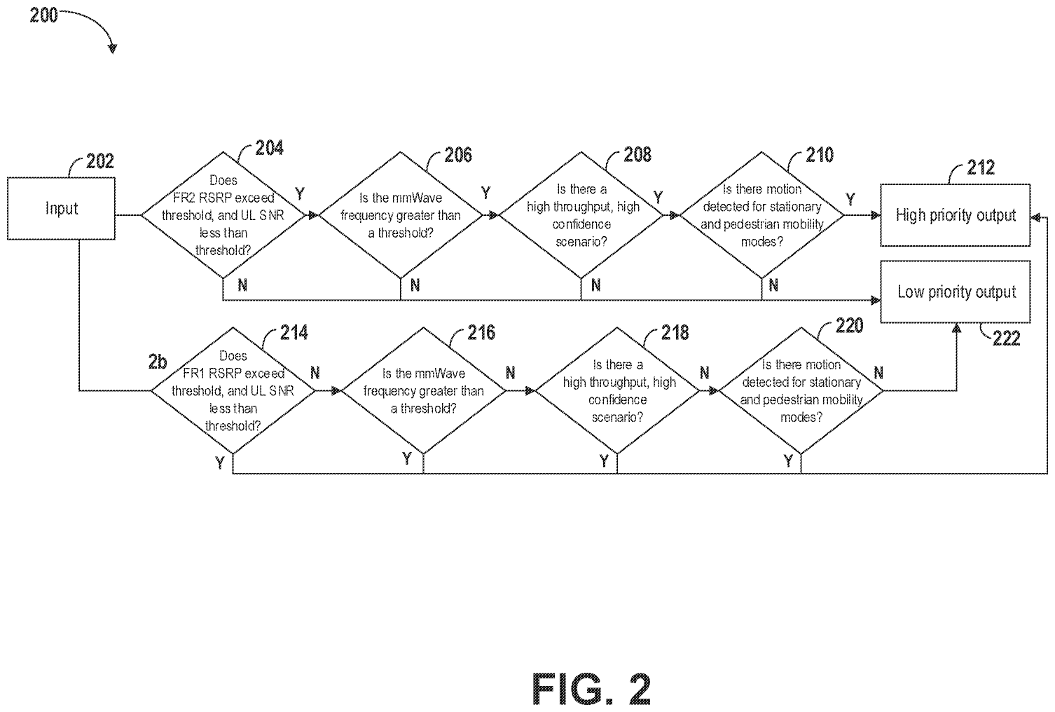

Turning to FIG. 2, the state machine 200 executed at step 108 is now described. The state machine 200 determines whether the UE is in a high priority mode or a low priority mode. The state machine 200 receives (202) input data that includes beam metrics such as frequency, RSRP values, SNR values, confidence scenario data, mobility mode, BWP, and high/low throughput indicators. If the UE is operating in FR1, the UE proceeds to decision point 204. If the UE is operating in FR2, the UE proceeds to decision point 214.

For FR2, the UE determines (204) whether the FR2 RSRP is worse than a RSRP threshold value. If the FR2 RSRP remains below the threshold value, it is likely that a beam failure is occurring. In some implementations, the threshold value for testing is about −103 dBm. However, the UE may be configured with outer RSRP values based on heuristic data or other calibration processes. The UE also checks the uplink SNR value to determine whether the SNR value satisfies an SNR threshold value. When the SNR of the beam is lower than the threshold value, the network switches the UL path from NR to LTE. In some implementations, the SNR threshold value is about 15 dB. However, the UE may be configured with outer RSRP values based on heuristic data or other calibration processes. If the FR2 RSRP exceeds the RSRP threshold value, and the UL SNR is less than the SNR threshold value, the UE proceeds to step 206. Else, when the RSRP is less than the threshold value or the SNR exceeds the SNR threshold value, the state machine outputs (222) a low priority mode output.

If a low priority scenario is not chosen the UE proceeds to determine (206) whether the mmWave operating frequency is greater than a threshold frequency. For example, the threshold is generally 29 gigaHertz (GHz). Generally, most cellular communication is below 29 GHz. Such frequencies cover a distance of up to 200-250 meters. When the operating frequency is greater than about 29 GHz, the communication is immune or nearly immune to high atmospheric and path loss. The UE should to go straight into the algorithm of beam failure recovery in this case. Generally, operating frequencies above 29 GHz covers distances of up to about 100-150 meters. If the threshold frequency is satisfied, the UE proceeds to check the confidence and throughput associated with the current beam. Else, the state machine outputs (222) a low priority mode output.

When the mmWave frequency is greater than 29 GHz, the UE proceeds to determine (208) if the UE is operating in both a high throughput and high confidence mode. For example, the UE checks a nature of data activity and determines whether it is a high throughput high confidence state or otherwise. To detect a high confidence state, the UE detects data over a length of time. Specifically, the UE checks a data threshold for a threshold amount of time. In a particular example, when the data is greater than about 16 Mbps for about 4 seconds, the UE determines that there is a high confidence, high throughput scenario.

When the beam is both in high throughput and high confidence modes, the UE proceeds to check the mobility mode. Else, if a low throughput or low confidence mode are being used with the current beam, the state machine outputs (222) a low priority mode output.

When the high confidence, high throughput mode for the current beam is confirmed, the UE proceeds to determine (210) if a mobility mode indicates motion is occurring. Specifically, the UE checks an input for motion detection. The UE checks for stationary or pedestrian mobility. A slow-moving UE is likely to have beam failures in challenging RFs. If motion is detected as experiencing vehicular mobility or a high speed, the UE is likely to get out of poor RF, and the UE can delay beam recovery for a time period.

The UE checks each of the stationary and pedestrian mobility modes. If the motion input is true for both modes, the state machine outputs (212) a high priority output. Else, if either of the mobility modes indicates that motion is not occurring, the state machine outputs (222) a low priority mode.

For FR1, the UE determines (214) whether the FR1 RSRP is worse than a RSRP threshold value that is generally different from the FR2 RSRP threshold. If the RSRP remains below the threshold value, it is likely that a beam failure is occurring. In some implementations, the threshold value for testing is about −112 dBm. However, the UE may be configured with outer RSRP values based on heuristic data or other calibration processes. The UE also checks the uplink SNR value to determine whether the SNR value satisfies an SNR threshold value. When the SNR of the beam is lower than the threshold value, the network switches the UL path from NR to LTE. In some implementations, the SNR threshold value is about 4 dB. However, the UE may be configured with outer RSRP values based on heuristic data or other calibration processes. If the FR1 RSRP exceeds the RSRP threshold value, and the UL SNR is less than the SNR threshold value, the UE outputs a high priority output (212). Else, when the RSRP is less than the threshold value or the SNR exceeds the SNR threshold value, the UE proceeds to step 216.

If a low priority scenario is not chosen the UE proceeds to determine (216) whether the mmWave operating frequency is greater than a threshold frequency. For example, the threshold is generally 29 gigaHertz (GHz). Generally, most cellular communication is below 29 GHz. Such frequencies cover a distance of up to 200-250 meters. When the operating frequency is greater than about 29 GHz, the communication is immune or nearly immune to high atmospheric and path loss. The UE should to go straight into the algorithm of beam failure recovery in this case. Generally, operating frequencies above 29 GHz covers distances of up to about 100-150 meters. If the threshold frequency is satisfied, the state machine outputs (212) a high priority mode. Else, the UE proceeds to check the confidence and throughput associated with the current beam and proceeds to step 218.

When the mmWave frequency is less than the threshold, the UE proceeds to determine (218) if the UE is operating in both a high throughput and high confidence mode. For example, the UE checks a nature of data activity and determines whether it is a high throughput high confidence state or otherwise. To detect a high confidence state, the UE detects data over a length of time. Specifically, the UE checks a data threshold for a threshold amount of time. In a particular example, when the data is greater than about 16 Mbps for about 4 seconds, the UE determines that there is a high confidence, high throughput scenario. When the beam is both in high throughput and high confidence modes, the state machine outputs (212) a high priority mode. Else, if a low throughput or low confidence mode are being used with the current beam, the UE proceeds to check the mobility mode.

When either a low confidence or low throughput mode for the current beam is confirmed, the UE proceeds to determine (220) if a mobility mode indicates motion is occurring. Specifically, the UE checks an input for motion detection. The UE checks for stationary or pedestrian mobility. A slow-moving UE is likely to have beam failures in challenging RFs. If motion is detected as experiencing vehicular mobility or a high speed, the UE is likely to get out of poor RF, and the UE can delay beam recovery for a time period.

The UE checks each of the stationary and pedestrian mobility modes. If the motion input is true for both modes, the state machine outputs (212) a high priority output. Else, if either of the mobility modes indicates that motion is not occurring, the state machine outputs (222) a low priority mode. The result of the state machine is therefore a high priority output or a low priority output.

Returning to FIGS. 1A-1B, at step 108, the state machine of FIG. 2 is executed and outputs a high priority or a low priority. If the output is a high priority, the UE flushes (112) the beam failure recover timer T₁ to reset state machine register values. The UE then determines (114) if a beam failure recovery configuration is configured for an active uplink bandwidth part (BWP). If such a configuration exists, the UE determines (116) whether the beam failure recovery timer is already running. If the beam failure recovery timer T₁ is already running, the UE returns to step 103 in which data flow occurs.

If the beam failure recovery timer is not already running, the UE changes (118) the BeamFailureRecovery timer to t+x1 for the high priority output from state the state machine of FIG. 2. In some implementations, x1 could be any value in milliseconds. Adding the offset x1 to the timer shortens the timer and enables beam recovery more quickly. The UE then starts (120) running the beam failure recovery timer and proceeds to initiate (146) the random access procedure (RACH) on the SpCell. In this way, the UE begins beam failure recovery more quickly relative to a timing for legacy beam failure recovery procedures.

For scenarios in which the UE experiences issues decoding the SSB, such as due to uplink BER, the UE performs a process similar to that previously described for when the UE detects beam failure. The UE detects (104) that SSB is impacted by UL BLER. The UE then determines (122) if the beam failure recovery timer configuration is configured for the active uplink bandwidth part. This step is similar to the step 114 previously described.

If the UE determines that the beam failure recovery is configured for the active uplink BWP, the UE determines (138) if the beam failure recovery is already running. This check is similar to step 116 previously described. If the beam failure recovery timer is already running, the UE returns to the data flow step 103. If the beam failure recovery timer is not already running, the UE determines (140) if a high speed motion mode has been triggered. If the high speed mode has been triggered, the UE changes the beam recovery timer to t+x2 to make the timer aggressive for high speed motion. In some implementations, x2 can be any value in milliseconds. This scenario may occur if the UE is in high speed motion, such as on a train or other vehicle. Adding the offset x2 to the timer shortens the timer and helps initiate beam failure recovery more quickly. The UE then initiates (144) beam failure recovery timer. If the high speed motion mode has not been triggered, the offset x2 is not added, and the UE proceeds directly to step 144 in which the beam recovery timer is initiated. The UE is then prepared to initiate (146) the RACH procedure.

In each of steps 114 and 122, the UE determines if the beam failure recovery configuration is configured for the active uplink BWP. Recall that for step 114, this is performed when beam failure was detected, and for step 122, this occurs when SSB decoding is affected by the uplink BLER. When the beam failure recovery configuration is not configured for the active uplink bandwidth part, the UE initiates (124) the RACH procedure on the SpCell. The UE initiates the RACH procedure in this context to initiate sub-process 101, in which the UE performs the RACH procedure when the beam failure recovery configuration is not configured for the active uplink bandwidth part.

In sub-process 101, the UE determines (126) if the RACH procedure is successful on the SpCell. If the RACH procedure is successful, the UE has reconnected to the base station, and the beam failure recovery is successfully completed (128). If the RACH procedure is unsuccessful, the UE increments (130) a RACH procedure counter. If the count is below a threshold, the UE repeats sub-process 101 until the RACH procedure is successful or until the counter does exceed a threshold number of attempts. When the counter value exceeds the threshold, the UE resets (134) the counter and declares (136) SCG failure.

Returning to step 146, the UE performs the RACH procedure on the SpCell in the context of the beam failure recovery configuration being configured for the uplink bandwidth part. In this context, the beam failure recovery timer has just been initiated with the appropriate offset x1 and/or x2 in milliseconds, depending on whether high speed mobility has occurred, whether a beam failure is detected, and/or whether the UE decoding of the SSB has been affected by the uplink BLER. When the UE initiates (146) the RACH procedure in this context, the UE performs the rest of process 100, shown in FIG. 1B.

The UE determines (152) whether the RACH is successful on the SpCell. When the UE RACH is successful, the UE stops (154) the beam recovery timer, and declares (156) the beam recovery to be complete. If the RACH is unsuccessful, the UE performs a following process that ensures an optimal solution in choosing a best beam and a best antenna module for the UE to attempt the RACH.

The UE is configured to determine (158) if a beam failure timer has expired. If the timer has expired, the UE declares (160) SCG failure.

If the beam failure timer has not expired, the UE latches (162) on to a different beam of the same antenna module as the current beam. During the first RACH attempt, the UE has selected a best possible beam and module. If the RACH has failed, the UE can use similar beam type and module, but use a different beam to increase a likelihood of RACH success in this subsequent attempt. The UE increments (164) the RACH procedure counter. If the counter does not exceed a first threshold, the UE repeats the RACH procedure from steps 146, 152, 158, and 162.

If the UE in step 166 exceeds the first threshold, the UE resets the counter value in step 168. UE can switch or latch (170) to a different antenna module to increase the likelihood of RACH success. The UE increments (172) the PRACH procedure counter. If the counter does not exceed a second threshold, the UE repeats the RACH procedure from steps 146, 152, 158, and 162 using the different antenna panel until a threshold number of attempts is reached

After a number of RACH iterations, the UE checks (174) a second threshold UE value to determine if a different antenna module (module) is to be checked. The UE resets the RACH counter and checks thermal ambient temperatures for each of the modules before determining whether to switch to another antenna module. For example, the UE switches the antenna module to attempt the RACH process. The UE checks the thermal ambient temperature and the temperature for each antenna module (m1, m2, m3 . . . etc.). The UE determines (178) if an ambient temperature is less than a threshold temperature for the first antenna module. If the temperature is less than a threshold (e.g., 28 degrees Celsius (° C.)), the UE selects (188) the first module for RACH. If the temperature exceeds the temperature threshold, the UE proceeds to the next antenna module.

The UE determines (180) if an ambient temperature for the second antenna module is less than a threshold temperature. If the second temperature is less than a second threshold temperature (e.g., 28 degrees ° C.), the UE selects (186) the second module for RACH. Else, the UE proceeds to the next (third) temperature module.

The UE determines (182) if an ambient temperature for the third antenna module is less than a threshold temperature. If the third temperature is less than a third threshold temperature (e.g., 28 degrees ° C.), the UE selects (184) the third module for RACH. Else, the UE proceeds to the next temperature module, if one exists. If none of the antenna modules have a temperature below the threshold temperature, and RACH is still unsuccessful, the UE declares (160) SCG failure. In some implementations, each the first, second, third, etc. modules can be any antenna modules for the UE. If a module is selected, the UE returns to initiating (146) the RACH procedure as previously described.

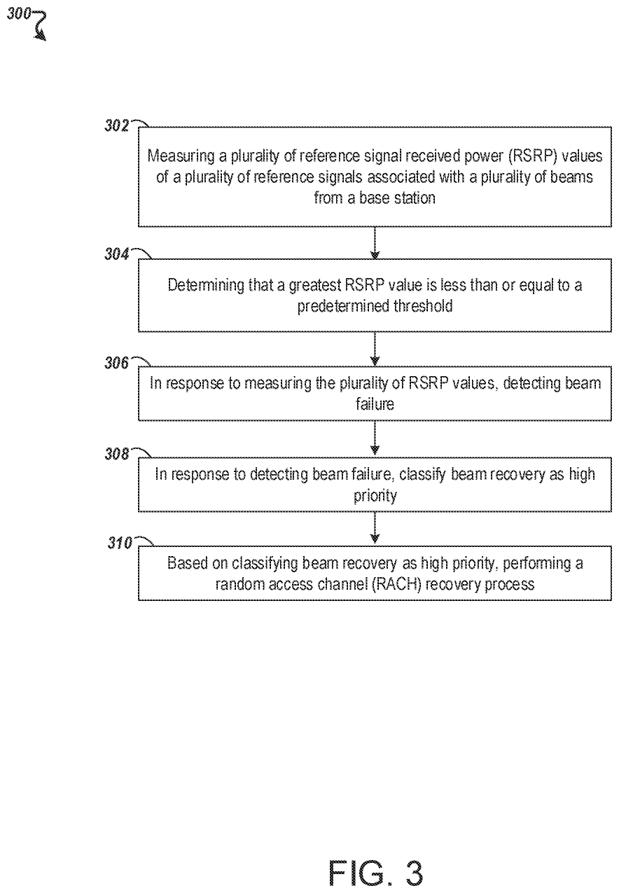

FIG. 3 shows a flow diagram that illustrates process 300 for opportunistic device recovery from transmission beam failures. The process 300 can be performed by the UEs 402 or 500 described in relation to FIGS. 4, 5, and 6 and FIGS. 1A-2. The process 300 includes measuring (302) a plurality of reference signal received power (RSRP) values of a plurality of reference signals associated with a plurality of beams from a base station. The process includes determining (304) that a greatest RSRP value is less than or equal to a predetermined threshold. The process 300 includes, based on measuring the plurality of RSRP values, detecting (306) beam failure. The process 300 includes, based on detecting beam failure, classifying (308) beam recovery as high priority. In some implementations, classifying the beam failure as high priority comprises testing a millimeter wave frequency as being greater or less than 29 gigahertz. In some implementations, classifying the beam failure as high priority comprises comparing a throughput of the beam to a threshold value. In some implementations, classifying the beam failure as high priority comprises determining if the UE is moving or stationary. In some implementations, classifying beam recovery as high priority causes the RACH recovery process to immediately initiate without waiting for a beam recovery timer to expire.

The process 300 includes, based on classifying beam recovery as high priority, performing (310) a random access channel (RACH) recovery process.

In some implementations, the RACH recovery process comprises determining that a number of RACH attempts with a first beam satisfies a threshold number of RACH attempts. In some implementations, the RACH recovery process comprises latching to a second beam in a same antenna module as the first beam. In some implementations, the RACH recovery process comprises performing RACH using the second beam.

In some implementations, the RACH recovery process comprises determining that a number of RACH attempts on a first antenna module satisfies a threshold number of RACH attempts. In some implementations, the RACH recovery process comprises measuring a first temperature associated with a first antenna module. In some implementations, the RACH recovery process comprises selecting the first antenna module based on the first temperature being below a threshold temperature. In some implementations, the RACH recovery process comprises performing RACH using a beam from the first antenna module.

In some implementations, the RACH recovery process comprises measuring a second temperature associated with a second antenna module. In some implementations, the RACH recovery process comprises selecting the second antenna module based on the second temperature being below the threshold temperature. In some implementations, the RACH recovery process comprises performing RACH using a beam from the second antenna module.

In some implementations, the UE is operating in Evolved-Universal Terrestrial Radio Access-New Radio (EN-DC). In some implementations, the base station is one of a gNodeB (gNB) or an eNB.

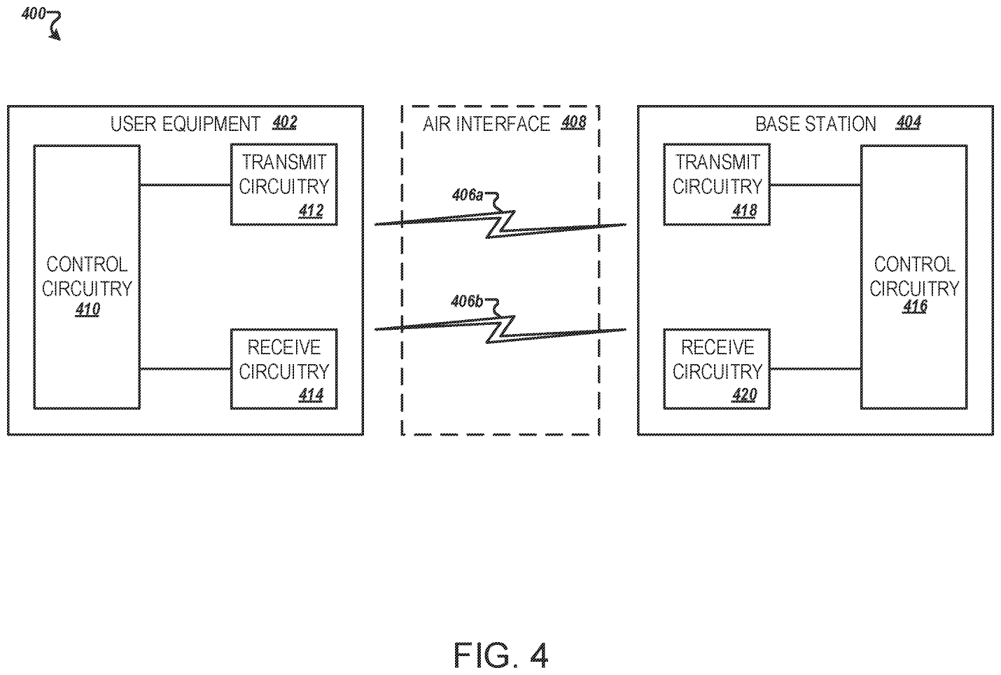

FIG. 4 illustrates a wireless network 400, in accordance with some embodiments. The wireless network 400 includes a UE 402 and a base station 404 connected via one or more channels 406A, 406B across an air interface 408. The UE 402 and base station 404 communicate using a system that supports controls for managing the access of the UE 402 to a network via the base station 404.

For purposes of convenience and without limitation, the wireless network 400 is described in the context of Long Term Evolution (LTE) and Fifth Generation (5G) New Radio (NR) communication standards as defined by the Third Generation Partnership Project (3GPP) technical specifications. More specifically, the wireless network 400 is described in the context of a Non-Standalone (NSA) networks that incorporate both LTE and NR, for example, E-UTRA (Evolved Universal Terrestrial Radio Access)-NR Dual Connectivity (EN-DC) networks, and NE-DC networks. However, the wireless network 400 may also be a Standalone (SA) network that incorporates only NR. Furthermore, other types of communication standards are possible, including future 3GPP systems (e.g., Sixth Generation (6G)) systems, Institute of Electrical and Electronics Engineers (IEEE) 802.11 technology (e.g., IEEE 802.11a; IEEE 802.11b; IEEE 802.11g; IEEE 802.11-2007; IEEE 802.11n; IEEE 802.11-2012; IEEE 802.11ac; or other present or future developed IEEE 802.11 technologies), IEEE 802.16 protocols (e.g., WMAN, WiMAX, etc.), or the like. While aspects may be described herein using terminology commonly associated with 5G NR, aspects of the present disclosure can be applied to other systems, such as 3G, 4G, and/or systems subsequent to 5G (e.g., 6G).

In the wireless network 400, the UE 402 and any other UE in the system may be, for example, laptop computers, smartphones, tablet computers, machine-type devices such as smart meters or specialized devices for healthcare monitoring, remote security surveillance systems, intelligent transportation systems, or any other wireless devices with or without a user interface. In network 400, the base station 404 provides the UE 402 network connectivity to a broader network (not shown). This UE 402 connectivity is provided via the air interface 408 in a base station service area provided by the base station 404. In some embodiments, such a broader network may be a wide area network operated by a cellular network provider, or may be the Internet. Each base station service area associated with the base station 404 is supported by antennas integrated with the base station 404. The service areas are divided into a number of sectors associated with certain antennas. Such sectors may be physically associated with fixed antennas or may be assigned to a physical area with tunable antennas or antenna settings adjustable in a beamforming process used to direct a signal to a particular sector.

The UE 402 includes control circuitry 410 coupled with transmit circuitry 412 and receive circuitry 414. The transmit circuitry 412 and receive circuitry 414 may each be coupled with one or more antennas. The control circuitry 410 may be adapted to perform operations associated with selection of codecs for communication and to adaption of codecs for wireless communications as part of system congestion control. The control circuitry 410 may include various combinations of application-specific circuitry and baseband circuitry. The transmit circuitry 412 and receive circuitry 414 may be adapted to transmit and receive data, respectively, and may include radio frequency (RF) circuitry or front-end module (FEM) circuitry, including communications using codecs as described herein.

In various embodiments, aspects of the transmit circuitry 412, receive circuitry 414, and control circuitry 410 may be integrated in various ways to implement the circuitry described herein. The control circuitry 410 may be adapted or configured to perform various operations such as those described elsewhere in this disclosure related to a UE. The transmit circuitry 412 may transmit a plurality of multiplexed uplink physical channels. The plurality of uplink physical channels may be multiplexed according to time division multiplexing (TDM) or frequency division multiplexing (FDM) along with carrier aggregation. The transmit circuitry 412 may be configured to receive block data from the control circuitry 410 for transmission across the air interface 408. Similarly, the receive circuitry 414 may receive a plurality of multiplexed downlink physical channels from the air interface 408 and relay the physical channels to the control circuitry 410. The plurality of downlink physical channels may be multiplexed according to TDM or FDM along with carrier aggregation. The transmit circuitry 412 and the receive circuitry 414 may transmit and receive both control data and content data (e.g., messages, images, video, etc.) structured within data blocks that are carried by the physical channels.

FIG. 4 also illustrates the base station 404. In embodiments, the base station 404 may be an NG radio access network (RAN) or a 5G RAN, an E-UTRAN, a non-terrestrial cell, or a legacy RAN, such as a UTRAN or GERAN. As used herein, the term “NG RAN” or the like may refer to the base station 404 that operates in an NR or 5G wireless network 400, and the term “E-UTRAN” or the like may refer to a base station 404 that operates in an LTE or 4G wireless network 400. The UE 402 utilizes connections (or channels) 406A, 406B, each of which includes a physical communications interface or layer.

The base station 404 circuitry may include control circuitry 416 coupled with transmit circuitry 418 and receive circuitry 420. The transmit circuitry 418 and receive circuitry 420 may each be coupled with one or more antennas that may be used to enable communications via the air interface 408.

The control circuitry 416 may be adapted to perform operations for analyzing and selecting codecs, managing congestion control and bandwidth limitation communications from a base station, determining whether a base station is codec aware, and communicating with a codec-aware base station to manage codec selection for various communication operations described herein. The transmit circuitry 418 and receive circuitry 420 may be adapted to transmit and receive data, respectively, to any UE connected to the base station 404 using data generated with various codecs described herein. The transmit circuitry 418 may transmit downlink physical channels includes of a plurality of downlink sub-frames. The receive circuitry 420 may receive a plurality of uplink physical channels from various UEs, including the UE 402.

In this example, the one or more channels 406A, 406B are illustrated as an air interface to enable communicative coupling, and can be consistent with cellular communications protocols, such as a GSM protocol, a CDMA network protocol, a PTT protocol, a POC protocol, a UMTS protocol, a 3GPP LTE protocol, an Advanced long term evolution (LTE-A) protocol, a LTE-based access to unlicensed spectrum (LTE-U), a 5G protocol, a NR protocol, an NR-based access to unlicensed spectrum (NR-U) protocol, and/or any of the other communications protocols discussed herein. In embodiments, the UE 402 may directly exchange communication data via a ProSe interface. The ProSe interface may alternatively be referred to as a SL interface and may include one or more logical channels, including but not limited to a PSCCH, a PSSCH, a PSDCH, and a PSBCH.

FIG. 5 illustrates an access node 500 (e.g., a base station or gNB), in accordance with some embodiments. The access node 500 may be similar to and substantially interchangeable with base station 104. The access node 500 may include processors 502, RF interface circuitry 504, core network (CN) interface circuitry 506, memory/storage circuitry 508, and antenna structure 510.

The components of the access node 500 may be coupled with various other components over one or more interconnects 512. The processors 502, RF interface circuitry 504, memory/storage circuitry 508 (including communication protocol stack 514), antenna structure 510, and interconnects 512 may be similar to like-named elements shown and described with respect to FIG. 6. For example, the processors 502 may include processor circuitry such as, for example, baseband processor circuitry (BB) 516A, central processor unit circuitry (CPU) 516B, and graphics processor unit circuitry (GPU) 516C.

The CN interface circuitry 506 may provide connectivity to a core network, for example, a 5th Generation Core network (5GC) using a 5GC-compatible network interface protocol such as carrier Ethernet protocols, or some other suitable protocol. Network connectivity may be provided to/from the access node 500 via a fiber optic or wireless backhaul. The CN interface circuitry 506 may include one or more dedicated processors or FPGAs to communicate using one or more of the aforementioned protocols. In some implementations, the CN interface circuitry 506 may include multiple controllers to provide connectivity to other networks using the same or different protocols.

As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can include ground stations (e.g., terrestrial access points) or satellite stations providing coverage within a geographic area (e.g., a cell). As used herein, the term “NG RAN node” or the like may refer to an access node 500 that operates in an NR or 5G system (for example, a gNB), and the term “E-UTRAN node” or the like may refer to an access node 500 that operates in an LTE or 4G system (e.g., an eNB). According to various embodiments, the access node 500 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

In some embodiments, all or parts of the access node 500 may be implemented as one or more software entities running on server computers as part of a virtual network, which may be referred to as a CRAN and/or a virtual baseband unit pool (vBBUP). In these embodiments, the CRAN or vBBUP may implement a RAN function split, such as a PDCP split wherein RRC and PDCP layers are operated by the CRAN/vBBUP and other L2 protocol entities are operated by the access node 500; a MAC/PHY split wherein RRC, PDCP, RLC, and MAC layers are operated by the CRAN/vBBUP and the PHY layer is operated by the access node 500; or a “lower PHY” split wherein RRC, PDCP, RLC, MAC layers and upper portions of the PHY layer are operated by the CRAN/vBBUP and lower portions of the PHY layer are operated by the access node 500.

In V2X scenarios, the access node 500 may be or act as RSUs. The term “Road Side Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like.

FIG. 6 illustrates a UE 600, in accordance with some embodiments. The UE 600 may be similar to and substantially interchangeable with UE 102 of FIG. 1. The UE 600 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, actuators, etc.), video surveillance/monitoring devices (for example, cameras, video cameras, etc.), wearable devices (for example, a smart watch), relaxed-IoT devices.

The UE 600 may include processors 602, RF interface circuitry 604, memory/storage 606, user interface 608, sensors 610, driver circuitry 612, power management integrated circuit (PMIC) 66, antenna structure 616, and battery 618. The components of the UE 600 may be implemented as integrated circuits (ICs), portions thereof, discrete electronic devices, or other modules, logic, hardware, software, firmware, or a combination thereof. The block diagram of FIG. 6 is intended to show a high-level view of some of the components of the UE 600. However, some of the components shown may be omitted, additional components may be present, and different arrangement of the components shown may occur in other implementations.

The components of the UE 600 may be coupled with various other components over one or more interconnects 620, which may represent any type of interface, input/output, bus (local, system, or expansion), transmission line, trace, optical connection, etc. that allows various circuit components (on common or different chips or chipsets) to interact with one another.

The processors 602 may include processor circuitry such as, for example, baseband processor circuitry (BB) 622A, central processor unit circuitry (CPU) 622B, and graphics processor unit circuitry (GPU) 622C. The processors 602 may include any type of circuitry or processor circuitry that executes or otherwise operates computer-executable instructions, such as program code, software modules, or functional processes from memory/storage 606 to cause the UE 600 to perform operations as described herein.

In some embodiments, the baseband processor circuitry 622A may access a communication protocol stack 624 in the memory/storage 606 to communicate over a 3GPP compatible network. In general, the baseband processor circuitry 622A may access the communication protocol stack to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a non-access stratum layer. In some embodiments, the PHY layer operations may additionally/alternatively be performed by the components of the RF interface circuitry 604. The baseband processor circuitry 622A may generate or process baseband signals or waveforms that carry information in 3GPP-compatible networks. In some embodiments, the waveforms for NR may be based cyclic prefix OFDM “CP-OFDM” in the uplink or downlink, and discrete Fourier transform spread OFDM “DFT-S-OFDM” in the uplink.

The memory/storage 606 may include one or more non-transitory, computer-readable media that includes instructions (for example, communication protocol stack 624) that may be executed by one or more of the processors 602 to cause the UE 600 to perform various operations described herein. The memory/storage 606 include any type of volatile or non-volatile memory that may be distributed throughout the UE 600. In some embodiments, some of the memory/storage 606 may be located on the processors 602 themselves (for example, L1 and L2 cache), while other memory/storage 606 is external to the processors 602 but accessible thereto via a memory interface. The memory/storage 606 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 604 may include transceiver circuitry and radio frequency front module (RFEM) that allows the UE 600 to communicate with other devices over a radio access network. The RF interface circuitry 604 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna structure 616 and proceed to filter and amplify (with a low-noise amplifier) the signal. The signal may be provided to a receiver of the transceiver that downconverts the RF signal into a baseband signal that is provided to the baseband processor of the processors 602.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 616.

In various embodiments, the RF interface circuitry 604 may be configured to transmit/receive signals in a manner compatible with NR access technologies.

The antenna 616 may include antenna elements to convert electrical signals into radio waves to travel through the air and to convert received radio waves into electrical signals. The antenna elements may be arranged into one or more antenna modules. The antenna 616 may have antenna modules that are omnidirectional, directional, or a combination thereof to enable beamforming and multiple input, multiple output communications. The antenna 616 may include microstrip antennas, printed antennas fabricated on the surface of one or more printed circuit boards, patch antennas, phased array antennas, etc. The antenna 616 may have one or more modules designed for specific frequency bands including bands in FRI or FR2.

The user interface 608 includes various input/output (I/O) devices designed to enable user interaction with the UE 600. The user interface 608 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs), or more complex outputs such as display devices or touchscreens (for example, liquid crystal displays “LCDs,” LED displays, quantum dot displays, projectors, etc.), with the output of characters, graphics, multimedia objects, and the like being generated or produced from the operation of the UE 600.

The sensors 610 may include devices, modules, or subsystems whose purpose is to detect events or changes in its environment and send the information (sensor data) about the detected events to some other device, module, subsystem, etc. Examples of such sensors include, inter alia, inertia measurement units including accelerometers, gyroscopes, or magnetometers; microelectromechanical systems or nanoelectromechanical systems including 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 612 may include software and hardware elements that operate to control particular devices that are embedded in the UE 600, attached to the UE 600, or otherwise communicatively coupled with the UE 600. The driver circuitry 612 may include individual drivers allowing other components to interact with or control various input/output (I/O) devices that may be present within, or connected to, the UE 600. For example, driver circuitry 612 may include a display driver to control and allow access to a display device, a touchscreen driver to control and allow access to a touchscreen interface, sensor drivers to obtain sensor readings of sensor circuitry 628 and control and allow access to sensor circuitry 628, drivers to obtain actuator positions of electro-mechanic components or control and allow access to the electro-mechanic components, a camera driver to control and allow access to an embedded image capture device, audio drivers to control and allow access to one or more audio devices.

The PMIC 66 may manage power provided to various components of the UE 600. In particular, with respect to the processors 602, the PMIC 66 may control power-source selection, voltage scaling, battery charging, or DC-to-DC conversion.

In some embodiments, the PMIC 66 may control, or otherwise be part of, various power saving mechanisms of the UE 600 including DRX as discussed herein. A battery 618 may power the UE 600, although in some examples the UE 600 may be mounted deployed in a fixed location, and may have a power supply coupled to an electrical grid. The battery 618 may be a lithium ion battery, a metal-air battery, such as a zinc-air battery, an aluminum-air battery, a lithium-air battery, and the like. In some implementations, such as in vehicle-based applications, the battery 618 may be a typical lead-acid automotive battery.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

### EXAMPLES

Example 1 may include a method for reference signal measurement reporting by a user equipment (UE) in a wireless communications system, the method involves: measuring a plurality of reference signal received power (RSRP) values of a plurality of reference signals associated with a plurality of beams from a base station; determining that a greatest RSRP value is less than or equal to a predetermined threshold; in response to measuring the plurality of RSRP values, detecting beam failure; in response to detecting beam failure, classify beam recovery as high priority; in response to classifying beam recovery as high priority, perform a random access channel (RACH).

Example 2 may include the method of example 1 and/or some other examples herein, wherein classifying the beam failure as high priority comprises testing a millimeter wave frequency as being greater or less than 29 gigahertz.

Example 3 may include the method of examples 1-2 and/or some other examples herein, wherein classifying the beam failure as high priority comprises comparing a throughput of the beam to a threshold value.

Example 4 may include the method of examples 1-3 and/or some other examples herein, wherein classifying the beam failure as high priority comprises determining if the UE is moving or stationary.

Example 5 may include the method of examples 1-4 and/or some other examples herein, wherein classifying beam recovery as high priority causes the RACH recovery process to immediately initiate without waiting for a beam recovery timer to expire.

Example 6 may include the method of examples 1-5 and/or some other examples herein, where the UE is operating in Evolved-Universal Terrestrial Radio Access-New Radio (EN-DC).

Example 7 may include the method of examples 1-5 and/or some other examples herein, where the base station is one of a gNodeB (gNB) or an eNB.

Example 8 may include an apparatus comprising means to perform one or more elements of a method described in or related to any of examples 1-7, or any other method or process described herein.

Example 9 may include one or more non-transitory computer-readable media comprising instructions to cause an electronic device, upon execution of the instructions by one or more processors of the electronic device, to perform one or more elements of a method described in or related to any of examples 1-7, or any other method or process described herein.

Example 10 may include an apparatus comprising logic, modules, or circuitry to perform one or more elements of a method described in or related to any of examples 1-7, or any other method or process described herein.

Example 11 may include a method, technique, or process as described in or related to any of examples 1-7, or portions or parts thereof.

Example 12 may include an apparatus comprising: one or more processors and one or more computer-readable media comprising instructions that, when executed by the one or more processors, cause the one or more processors to perform the method, techniques, or process as described in or related to any of examples 1-7, or portions thereof.

Example 13 may include a computer program comprising instructions, wherein execution of the program by a processing element is to cause the processing element to carry out the method, techniques, or process as described in or related to any of examples 1-7, or portions thereof.

Example 14 may include a system for providing wireless communication as shown and described herein.

Example 15 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

1. A method for reference signal measurement reporting by a user equipment (UE) in a wireless communications system, the method comprising:
measuring a plurality of reference signal metric values of a plurality of reference signals associated with a plurality of beams from a base station;
determining that a greatest reference signal metric value is less than or equal to a predetermined threshold;
based the determining, detecting a beam failure;
based on detecting beam failure, classifying beam recovery as high priority;
based on classifying beam recovery as high priority, performing a random access channel (RACH) recovery process.

2. The method of claim 1, wherein the RACH recovery process comprises:
determining that a number of RACH attempts with a first beam satisfies a threshold number of RACH attempts;
latching to a second beam in a same antenna module as the first beam; and
performing RACH using the second beam.

3. The method of claim 1, wherein the RACH recovery process comprises:
determining that a number of RACH attempts on a first module satisfies a threshold number of RACH attempts;
measuring a first temperature associated with a first antenna module;
selecting the first antenna module based on the first temperature being below a threshold temperature; and
performing RACH using a beam from the first antenna module.

4. The method of claim 3, wherein the RACH recovery process comprises:
measuring a second temperature associated with a second antenna module;
selecting the second antenna module based on the second temperature being below the threshold temperature; and
performing RACH using a beam from the second antenna module.

5. The method of claim 1, wherein classifying the beam failure as high priority comprises testing a millimeter wave frequency as being greater or less than 29 gigahertz.

6. The method of claim 1, wherein classifying the beam failure as high priority comprises comparing a throughput of the beam to a threshold value.

7. The method of claim 1, wherein classifying the beam failure as high priority comprises determining if the UE is moving or stationary.

8. The method of claim 1, wherein classifying beam recovery as high priority causes the RACH recovery process to immediately initiate without waiting for a beam recovery timer to expire.

9. The method of claim 1, wherein the UE is operating in Evolved-Universal Terrestrial Radio Access-New Radio (EN-DC).

10. The method of claim 1, wherein the base station is one of a gNodeB (gNB) or an eNB.

11. One or more processors of a user equipment in a wireless system, the one or more processors configured to perform operations comprising:
measuring a plurality of reference signal metric values of a plurality of reference signals associated with a plurality of beams from a base station;
determining that a greatest reference signal metric value is less than or equal to a predetermined threshold;
based the determining, detecting a beam failure;
based on detecting beam failure, classifying beam recovery as high priority;
based on classifying beam recovery as high priority, performing a random access channel (RACH) recovery process.

12. The one or more processors of claim 11, wherein the RACH recovery process comprises:
determining that a number of RACH attempts with a first beam satisfies a threshold number of RACH attempts;
latching to a second beam in a same antenna module as the first beam; and
performing RACH using the second beam.

13. The one or more processors of claim 11, wherein the RACH recovery process comprises:
determining that a number of RACH attempts on a first module satisfies a threshold number of RACH attempts;
measuring a first temperature associated with a first antenna module;
selecting the first antenna module based on the first temperature being below a threshold temperature; and
performing RACH using a beam from the first antenna module.

14. The one or more processors of claim 13, wherein the RACH recovery process comprises:
measuring a second temperature associated with a second antenna module;
selecting the second antenna module based on the second temperature being below the threshold temperature; and
performing RACH using a beam from the second antenna module.

15. The one or more processors of claim 11, wherein classifying the beam failure as high priority comprises testing a millimeter wave frequency as being greater or less than 29 gigahertz.

16. The one or more processors of claim 11, wherein classifying the beam failure as high priority comprises comparing a throughput of the beam to a threshold value.

17. The one or more processors of claim 11, wherein classifying the beam failure as high priority comprises determining if the UE is moving or stationary.

18. The one or more processors of claim 11, wherein classifying beam recovery as high priority causes the RACH recovery process to immediately initiate without waiting for a beam recovery timer to expire.

19. The one or more processors of claim 11, wherein the UE is operating in Evolved-Universal Terrestrial Radio Access-New Radio (EN-DC).

20. The one or more processors of claim 11, wherein the base station is one of a gNodeB (gNB) or an eNB.
